(19) United States
(12) Patent Application Publication
(10) Pub. No.: US 2008/0045766 A1
(43) Pub. Date: Feb. 21, 2008

(54) Supported Catalyst Comprising Delta- Or Theta-Modified Aluminium Oxide Supports

(76) Inventors: Markus Schubert, Ludwigshafen (DE); Jurgen Stephan, Mannheim (DE); Volker Bohn, Frankenthal (DE); Andreas Brodhagen, Ludwigshafen (DE); Frank Poplow, Ludwigshafen (DE)

Correspondence Address: CONNOLLY BOVE LODGE & HUTZ, LLP, P O BOX 2207, WILMINGTON, DE, 19899, US

(21) Appl. No.: 10/590,979

(22) PCT Filed: Feb. 24, 2005
(86) PCT No.: PCT/EP05/01914

§ 371 Date: Jun. 29, 2007

(30) Foreign Application Priority Data
Feb. 28, 2004 (DE) 10 2004 009 803.4

(51) Int. Cl. B01J 21/04; B01J 23/36; B01J 32/00; B01J 37/08

(52) U.S. Cl. 585/534; 502/241; 502/243; 502/355; 585/500

(57) ABSTRACT

Process for producing a supported catalyst which comprises at least 75% by weight of Al₂O₃, whose proportion of Al₂O₃ in the delta or theta modification is, based on the proportion of Al₂O₃, at least 1% and which comprises a rhenium compound and, if appropriate, a promoter as active component (A), which comprises
a) converting a customary support (S) which comprises at least 75% by weight of Al₂O₃ and to which a promoter may, if appropriate, have been applied is converted into a modified support (S) whose proportion of Al₂O₃ in the delta or theta modification is, based on the proportion of Al₂O₃, at least 1% by calcining the customary support (S) at a temperature of from 750 to 1100°C.,
b) producing a supported catalyst precursor from the modified support (S) by applying the active component (A) comprising the rhenium compound to the modified support (S) and
c) calcining the supported catalyst precursor at a temperature of from 500 to 750° C.

The present invention relates to a supported catalyst, processes for producing it and processes for the metathesis of nonaromatic unsaturated hydrocarbon compounds using the supported catalyst.

The metathesis of nonaromatic unsaturated hydrocarbon compounds is a long-established method of breaking and reforming C—C bonds (cf. Mol, J. C., Chapt. 4.12.2 “Alkene Metathesis” in “Handbook of Heterogeneous Catalysis”, Eds. Ertl, G., Knözinger, H., Weitkamp, J., VCH, Weinheim 1997; Weissermehl, K., Arpe, H.-J., Chapt. 3.4 “Olefin-Metathese” in “Industrielle Organische Chemie”, 4th edition, VCH, Weinheim 1994). Various types of catalysts have been described for heterogeneously catalyzed metathesis. In the temperature range up to about 120° C., the use of supported Re₂O₇ or Re(CO)₁₀ catalysts is customary (Mol, J. C., Chapt. 4.12.2 “Alkene Metathesis” in “Handbook of Heterogeneous Catalysis”, Eds. Ertl, G., Knözinger, H., Weitkamp, J., VCH, Weinheim 1997). Supports available to a person skilled in the art for this purpose include Al₂O₃. This is present as eta or gamma Al₂O₃ in the finished catalyst. Shaped bodies such as extrudates, spheres, crushed material or pellets are customarily used as precursors for the support material. In the production of the shaped bodies, the support materials are usually calcined at temperatures of about 400-600° C., giving the pure gamma-Al₂O₃ phase, and possibly also, depending on the reaction conditions, eta-Al₂O₃. However, the phase transition to delta- or theta-Al₂O₃ is not ruled out under these conditions.

DE 19,947,352 describes a catalyst comprising at least three components: an aluminum oxide support comprising at least 0.5% of delta-Al₂O₃, 0.01-20% by weight of rhenium oxide and from 0.01-5% by weight of Cs. To obtain this, a catalyst precursor is firstly produced by applying the active components to pure delta-Al₂O₃ and is subsequently calcined at temperatures of 750° C.-1000° C. A disadvantage of the abovementioned catalysts is, firstly, the presence of an alkali metal component which leads to a reduced catalyst life due to gradual formation of coarsely crystalline, unreactive alkali metal perrhenates and at high concentrations in various metathesis reactions can also lead to impairment of the activity. Secondly, calcination of the Re-containing catalyst precursors at temperatures of about 800° C. or above leads to significant losses of active component as a result of vaporization of rhenium peroxide, which has a considerable adverse effect on the economics of the process.

It was an object of the present invention to provide supported catalysts for the metathesis of hydrocarbons having a nonaromatic C—C double bond or C—C triple bond which maintain a high activity over a very long period of use. A further object was to provide an economical process by means of which such catalysts can be produced.

We have accordingly found a process for producing a supported catalyst which comprises at least 75% by weight of Al₂O₃, whose proportion of Al₂O₃ in the delta or theta modification is, based on the proportion of Al₂O₃, at least 1% and which comprises a rhenium compound and, if appropriate, a promoter as active component (A), which comprises

a) converting a customary support (S) which comprises at least 75% by weight of Al₂O₃ and to which a promoter may, if appropriate, have been applied is converted into a modified support (S) whose proportion of Al₂O₃ in the delta or theta modification is, based on the proportion of Al₂O₃, at least 1% by calcining the customary support (S) at a temperature of from 750 to 1100° C.,

b) producing a supported catalyst precursor from the modified support (S) by applying the active component (A) comprising the rhenium compound to the modified support (S) and

c) calcining the supported catalyst precursor at a temperature of from 500 to 750° C.

As support (S), it is usual to employ commercial Al₂O₃. Such Al₂O₃ comprises mainly gamma-Al₂O₃. The total proportion of delta- and theta-Al₂O₃ is, based on all Al₂O₃ modifications, generally at least <1%. However, it is also possible to use Al₂O₃ having higher contents of delta- and theta-Al₂O₃ as support (S) if the supported catalyst is to have a higher content thereof. It is important that the contents of delta- and theta-Al₂O₃ in the support (S) used is lower than the content in the supported catalyst of the invention.

Instead of using commercial gamma-Al₂O₃ supports, it is also possible to calcine a precursor thereof, e.g. hydrargillite, boehmite or pseudoboehmite, directly at the temperatures necessary to form delta- or theta-Al₂O₃ without the gamma-Al₂O₃ being isolated first as intermediate. Delta- or theta-containing shaped support bodies produced in this way are in principle obtainable as commerical niche products.

Apart from aluminum oxide, the support (S) may, if appropriate, further comprise additional customary support materials, preferably materials selected from the group consisting of SiO₂, aluminosilicates, TiO₂, ZrO₂, MgO, CeO₂ or ZnO.

To improve the physical properties of the catalyst, further lubricants and additives such as graphite, cement, gypsum or muscovite can be incorporated in addition to the actual support material.

The catalyst of the invention and, if appropriate, the support (S) before production of the catalyst is/are preferably in the form of shaped bodies. For the purposes of the present invention, shaped bodies are bodies having geometries as are generally customary for catalysts, i.e. spheres, crushed material, extrudates or pellets. The smallest mean diameter of such shaped bodies is usually more than 0.5 mm and the largest mean diameter is usually less than 5 mm.

All customary shaping methods such as extrusion or tabletting are suitable for producing the shaped bodies.

Calcination preferably takes place at a temperature of from 750 to 1100° C. For the purposes of the present invention, calcination is heating in an oxidative gas atmosphere, e.g. a gas atmosphere comprising oxygen and otherwise inert constituents. The preferred gas atmosphere is air.

Increasing the time and raising the temperature of the calcination enables the proportion of Al₂O₃ in the delta or theta modification relative to the gamma modification to be increased. Calcination temperatures above 1100° C. are not recommended because a transition to alpha-Al₂O₃ takes place under these conditions and this is undesirable since the surface area of the support material then decreases too much. The total proportion of Al₂O₃ in the delta or theta modification is, based on the proportion of Al₂O₃, preferably at least 10%.

The support can, if appropriate, be pretreated with alcohols or modified so as to make it acidic by application of, for example, phosphoric acid, hydrochloric acid, sulfuric acid or ammonium hydrogenphosphate. This modification can be carried out after or preferably before calcination.

For technical reasons, calcination is usually carried out for from 1 to 20 hours, but the time generally tends to be relatively unimportant. After the treatment, the supports have a surface area of from 20 to 200 m²/g, preferably greater than 40 m²/g, and a pore volume of at least 0.20 ml/g, preferably at least 0.35 ml/g. The pore structure of the modified support (S) after calcination is such that the maximum of the distribution function for the pore diameter in the mesopore range (pore sizes of from 2 nm to 50 nm) is usually at values above 10 nm, preferably above 12 nm. The determination of the pore size and volume and their distribution is carried out in accordance with DIN 66133 of June 1993 and DIN 66134 of February 1998, published by the Deutsche Institut für Normung e.V.

A supported catalyst precursor is produced from the modified support (S) by applying the active component (A) comprising at least one compound of rhenium. Possible rhenium compounds are the sulfides, oxides, nitrides, carbonyls, halides or acids. Particular preference is given to ammonium perrhenate or, in particular, perrhenic acid and rhenium heptoxide. The rhenium component can be applied to the support material by all customary methods. These include, for example, methods such as impregnation in an excess of solution, “dry impregnation” (i.e. calculated on the basis of the respective water absorptions, sublimation, especially for carbonyls). If necessary, water is preferably used as solvent for the rhenium components, but it is also possible to use organic solvents such as alcohols or dioxane. The proportion of the active component (A) in the supported catalyst is usually from 0.1 to 30% by weight. Preference is given to rhenium oxide in an amount of from 0.5 to 15% by weight as active component. The rhenium oxide is particularly preferably present in crystallites smaller than 1 nm on the surface. This corresponds to rhenium surface areas (determined by means of N₂O chemisorption) of greater than 0.4 m²/g, as described in DE-A-19,837,203 for coated catalysts.

In addition to the rhenium component, the active component (A) can further comprise a promoter, i.e. one or more further compounds which optimize the activity or selectivity of the finished catalyst. Examples which may be mentioned here are phosphorus oxide, iron oxide, zirconium oxide, silicon oxide, tantalum oxide, niobium oxide, tungsten oxide, molybdenum oxide, oxides of the elements of the lanthanide series, vanadium oxide, lead compounds or tin compounds. The additional compounds can be applied before, after or simultaneously with the rhenium component, and intermediate calcinations at temperatures up to 600° C. are also possible if appropriate. On the other hand, the presence of alkali metals is avoided according to the invention, since these can form stable coarsely crystalline alkali metal perrhenates which shorten the total life of the catalyst and, secondly, in relatively high concentrations can also directly reduce the catalyst activity which would have to be compensated by a higher mass of catalyst.

As a result of appropriate choice of highly pure starting materials having a suitable specification, the supported catalysts of the invention generally have a total alkali metal content of less than 0.1% by weight (calculated as metal), preferably less than 700 ppm by weight, particularly preferably less than 100 ppm by weight. In particular, the values for the higher homologues, i.e. the potassium, rubidium and cesium content, are in each case less than 50 ppm by weight, preferably less than 30 ppm by weight, particularly preferably less than 10 ppm by weight.

Before use, the supported catalyst precursor is calcined at temperatures of at least 400° C., preferably at least 550° C. but not more than 750° C., in an oxygen-containing stream and is subsequently cooled to the reaction temperature, preferably in an inert stream such as N₂. The change from the oxygen-containing atmosphere to the inert gas atmosphere usually occurs at temperatures above 200° C., preferably at temperatures above 300° C. but not more than 750° C. If the catalyst is not to be used immediately but to be temporarily stored, cooling can also occur in air, but in this case a further activation according to the above-described procedure should be carried out before use.

The most intense reflection of the aluminum oxides is typically in the range from 2 theta >66° to 2 theta <68°. In addition, further reflections occur when the delta and/or theta modifications are present. As a consequence, the maximum of at least one reflection of the supported catalysts of the invention is to be found in the range from 2 theta >32.5° to 2 theta <37.4°, preferably at least the maximum of two reflections. Preference is given to supported catalysts in which at least one reflection whose maximum is in the range from 2 theta >32.5° to 2 theta <37.4° has an intensity ratio (counts/counts) to the reflection in the range from 2 theta >66° to 2 theta <68° of at least 0.05, preferably at least 0.15, very particularly preferably at least 0.35.

Particular preference is also given to materials in which additional reflections in the range from 2 theta >50.0° to 2 theta <53.0° can be seen under the specified measurement conditions.

The supported catalysts of the invention are particularly useful for preparing a compound having a nonaromatic C—C double bond or C—C triple bond (compound A) from another compound or mixture of other compounds having a nonaromatic C—C double bond or C—C triple bond (compound B) by bringing the compound (B) into contact with a supported catalyst, which has been produced by the process of the invention, at a temperature of from 50 to 500° C.

Such processes are generally known and described, for example, in “Industrielle Organische Chemie”, Klaus Weissermel, Hans-Jürgen Erpel, 5th edition, Verlag Wiley, VCH, 1998, Chapter 3.4 and “Handbook of Heterogeneous Catalysis”, edited by G. Ertl, H. Knözinger and J. Weitkamp, Volume 5, VCH Verlagsgesellschaft mbH, Weinheim, Chapter 4.12.2, Alkene Metathesis, pages 2387 to 2399. However, they can also be used for the metathesis of unsaturated esters, nitrites, ketones, aldehydes, acids or ethers, as described, for example, in Xiaoding, X., Imhoff, P., von den Aardweg, C. N., and Mol, J. C., J. Chem. Soc., Chem. Comm. (1985), p. 273. In the reaction of substituted olefins, a cocatalyst, for example a tin alkyl, lead alkyl or aluminum alkyl, is frequently used in order to achieve an additional increase in the activity.

Here, the supported catalysts produced by the processes according to the invention can be used in the same way as the known metathesis catalysts. The catalysts produced by the process of the invention are particularly advantageously used in metathesis processes for preparing propene by metathesis of a mixture comprising 2-butene and ethylene or 1-butene and 2-butenes, and for preparing 3-hexene and ethylene by metathesis of 1-butene. Corresponding processes are described in detail in DE-A-19813720, EP-A-1134271, WO 02/083609, DE-A-10143160.

The abovementioned C₄ starting compounds are usually supplied in the form of a raffinate II. The term raffinate II refers to C₄ fractions which generally have a butene content of from 30 to 100% by weight, preferably from 40 to 98% by weight. Apart from butenes, saturated C₄-alkanes in particular can also be present. The production of such raffinates II is generally known and is described, for example, in EP-A-1134271.

In particular, it is possible to use 1-butene-comprising olefin mixtures or 1-butene obtained by distilling a 1-butene-rich fraction off from raffinate II. 1-Butene can likewise be obtained from the 2-butene-rich fraction which remains by subjecting the 2-butene-rich fraction to an isomerization reaction and subsequently fractionally distilling it to give a 1-butene-rich fraction and a 2-butene-rich fraction. This process is described in DE-A-10311139.

The catalysts produced by the process of the invention are particularly useful for reactions in the liquid phase at temperatures of from 10 to 150° C. and a pressure of from 5 to 100 bar.

### Experimental Part

The XRD measurements below were carried out by means of a Siemens D-5000 diffractometer using Cu-K-alpha radiation, measurement with variable V-20 diaphragms on primary and secondary sides and a secondary monochromator to reduce fluorescence radiation. Measurements were made in steps of 0.02° with a step time of 3.6 s. Signals which are close together can form a broadened or asymmetric peak in the diffraction pattern due to superposition. Although these could in theory be separated by mathematical modeling, the results of such a peak fitting procedure can display wide scatter depending on the boundary conditions of the model employed. To rule out such uncertainties, the term reflection will hereinafter be used to mean a maximum which is clearly visible to the naked eye above the noise. Broadened or asymmetric signals will therefore be regarded as single reflections. The position of the maximum (=highest signal intensity) is the critical parameter here.

### EXAMPLE 1

### Production of a Catalyst According to the Invention (A-85999)

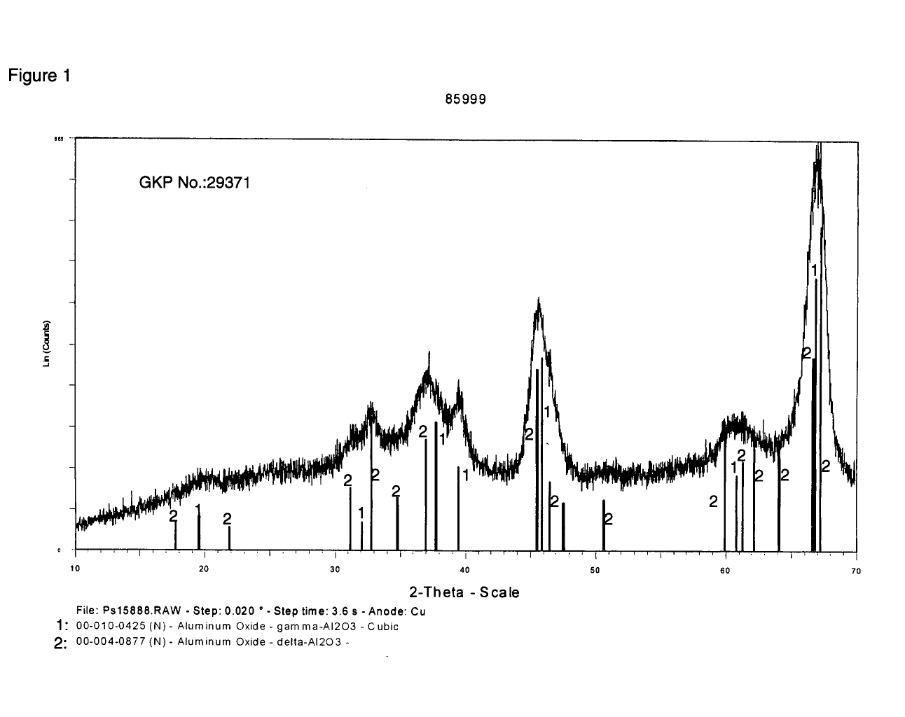

Commercial D10-21 extrudates (1.5 mm gamma-Al₂O₃ extrudates from BASF AG) were heated at 850° C. in air for 2 hours (during their production, the extrudates had been exposed to temperatures of not more than 600° C.). The extrudates were subsequently impregnated with an aqueous perrhenic acid solution to 90% of the water absorption and dried at 120° C. in air for 6 hours. The temperature was subsequently increased to 520° C. over a period of 2 hours, then to 550° C. over a further period of 15 minutes and the catalyst was calcined at this temperature for 2 hours. The catalyst was cooled and stored in air. The finished catalyst comprised 9.5% by weight of Re₂O₇. The pore volume determined by means of mercury porosimetery was 0.53 ml/g, and the surface area was 129 m²/g. The maximum in the distribution function over the pore size distribution in the mesopore range was 13 nm. A mixture of delta- and theta-Al₂O₃ phases was identified by means of X-ray diffraction (FIG. 1). Reflections having maxima at 2 theta=32.76° and 2 theta=37.05° can be seen. The intensity ratio (counts/counts) of the two reflections to the main reflection at 67.07° is 0.36 and 0.45, respectively. An additional, very weak reflection could be seen at 2 theta=50.6°. The Cs content of this sample is <10 ppm (detection limit). The K and Na contents were in each case <30 ppm (detection limit).

### EXAMPLE 2

### Production of a Catalyst According to the Invention (B-86000)

A catalyst was produced as described in example 1, but the support extrudates were in this case pretreated at 1000° C. in air for 2 hours.

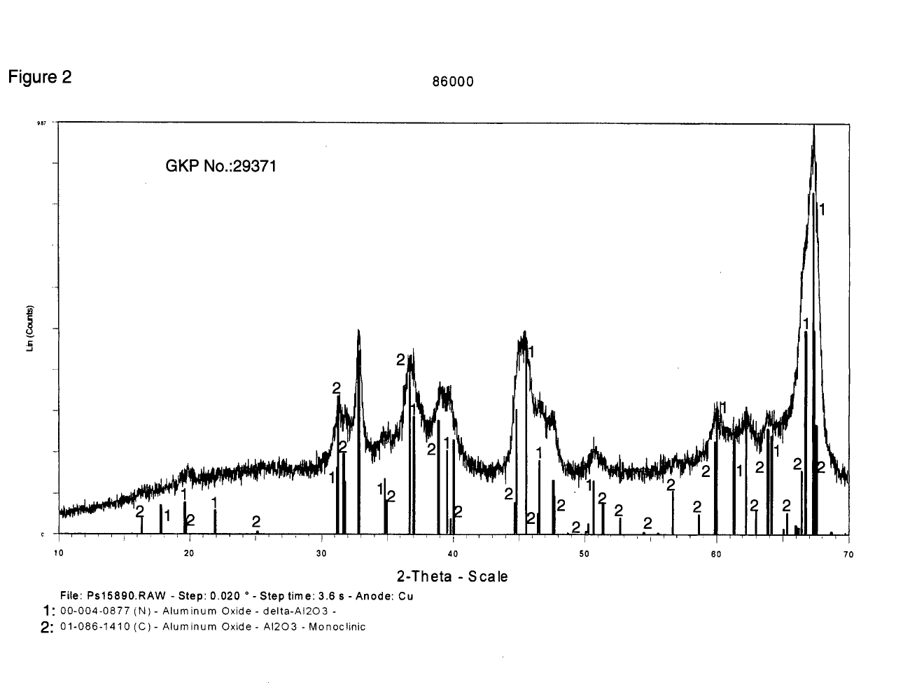

The finished catalyst comprised 9.9% by weight of Re₂O₇. The pore volume determined by means of mercury porosimetery was 0.44 ml/g, and the surface area was 89 m²/g. The maximum in the distribution function over the pore size distribution in the mesopore range was 15 nm. A mixture of delta- and theta-Al₂O₃ phases was identified by means of X-ray diffraction (FIG. 2). Reflections having maxima at 2 theta.=32.79° C. and 2 theta=36.73° can be seen. The intensity ratio (counts/counts) of the two reflections to the main reflection at 67.34° is 0.51 and 0.45, respectively.

A gamma phase could no longer be seen in the XRD. In addition, a distinct reflection could be seen at 2 theta=50.7°. The Cs content of this sample is <10 ppm (detection limit). The K and Na contents were in each case <30 ppm (detection limit).

### EXAMPLE 3

### Production of a Comparative Example (C-85850)

A catalyst was produced as described in example 1, but the support extrudates were not additionally pretreated.

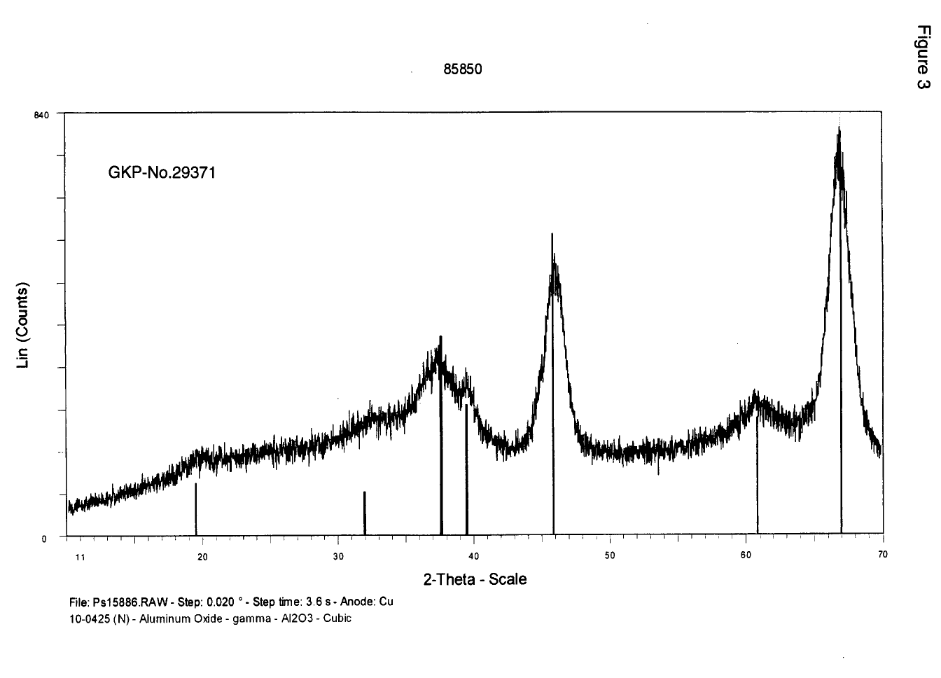

The finished catalyst comprised 9.0% by weight of Re₂O₇. The pore volume determined by means of mercury porosimetery was 0.52 ml/g, and the surface area was 158 m²/g. The maximum in the distribution function over the pore size distribution in the mesopore range was at 9.8 nm. Pure γ-Al₂O₃ is identified by means of X-ray diffraction (FIG. 3). All reflection maxima were outside the 2 theta range from 32.5° to 37.4°. Even in the range from 2 theta>50.0° and 2 theta<53.0°, no reflection was to be seen under the measurement conditions chosen. The Cs content of this sample was <10 ppm (detection limit). The K and Na contents were in each case <30 ppm (detection limit).

### EXAMPLES 4-6

### Comparison of the Performance of the Catalysts A-C

9 g of catalyst were in each case installed in a tube reactor. The feed consists of 162 g/h of a mixture of about 85-90% of linear butenes, about 2.5% of isobutene and butanes as balance (raffinate II). To compensate for the somewhat lower rhenium content of the sample C, the feed rate was reduced by about 5% in this measurement. The reaction conditions are in each case 35° C. and 35 bar. The composition of the stream leaving the reactor is monitored by means of on-line GC. As representatives of the numerous components, the amounts of the most important or largest products, i.e. propene, trans-2-pentene and trans-3-hexene, at different measurement times are shown in the following table. All products not shown (ethylene, cis-2-pentene, cis-3-hexene, 2-methyl-2-butene and 2-methyl-2-pentene) have in principle a similar time profile and comparable differences at prolonged running times.

| | Ex. A (85999) | | | Ex. B (86000) | | |
|---|---|---|---|---|---|---|
| | Propene | | | Propene | | |
| T | [% by | trans-2-Pentene | trans-3-Hexene | [% by | trans-2-Pentene | trans-3-Hexene |
| [h] | weight] | [% by weight] | [% by weight] | weight] | [% by weight] | [% by weight] |
| 4 | 13.1 | 15.1 | 3.5 | 14.1 | 15.8 | 4.0 |
| 9 | 10.4 | 11.6 | 2.2 | 11.5 | 12.3 | 2.6 |
| 17 | 7.7^{(-42%)} | 8.2^{(-46%)} | 1.1^{(-69%)} | 8.6^{(-39%)} | 8.6^{(-46%)} | 1.3^{(-67%)} |
| | Comp. Ex. C (85850) | | | | | |
| | Propene | | | | | |
| T | [% by | trans-2-Pentene | trans-3-Hexene | — | | |
| [h] | weight] | [% by weight] | [% by weight] | — | — | — |
| 4 | 11.5 | 12.6 | 2.5 | — | — | — |
| 9 | 8.8 | 8.9 | 1.5 | — | — | — |
| 17 | 6.1^{(-47%)} | 6.7^{(-47%)} | 0.8^{(-67%)} | — | — | — |

It can be seen that the catalysts according to the invention have higher initial activities throughout (differences up to about 40%) and specifically in respect of the lighter products (here: propene) deactivate somewhat more slowly, so that higher conversions are still achieved after a prolonged running time, which significantly increases the total yield.

### EXAMPLE 7, 8

### Transmission Electron Micrographs of Catalysts Containing Alkali Metals (Comparative Examples)

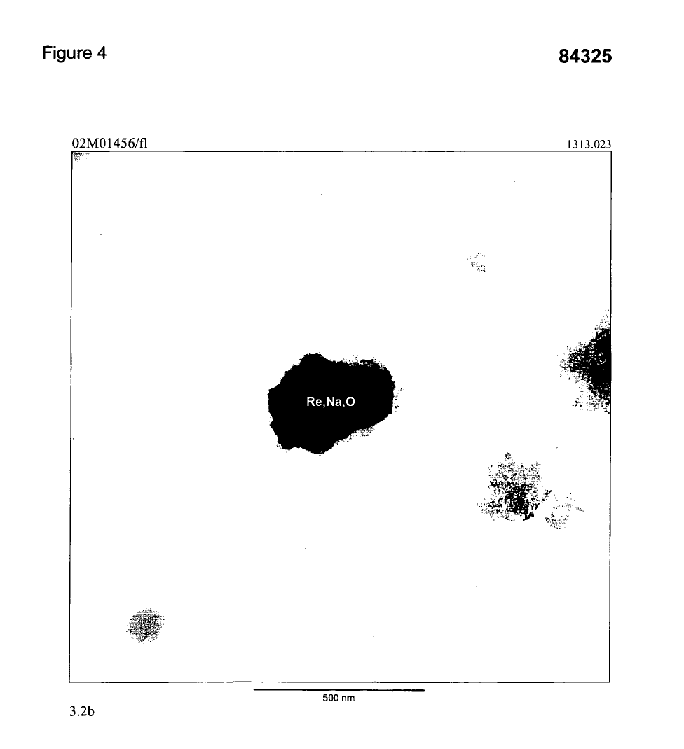

Catalyst D (84325) was produced by impregnation of an aluminum oxide support containing about 250 ppm of Na (based on the metal) as impurity with perrhenic acid. Examination by means of TEM (transmission electron microscopy, FIG. 4) showed coarse Na-Re-containing crystals. In contrast, pure rhenium oxide formed a highly disperse phase on Al₂O₃ supports. These units were usually smaller than 4 nm and mostly could not be seen by means of TEM.

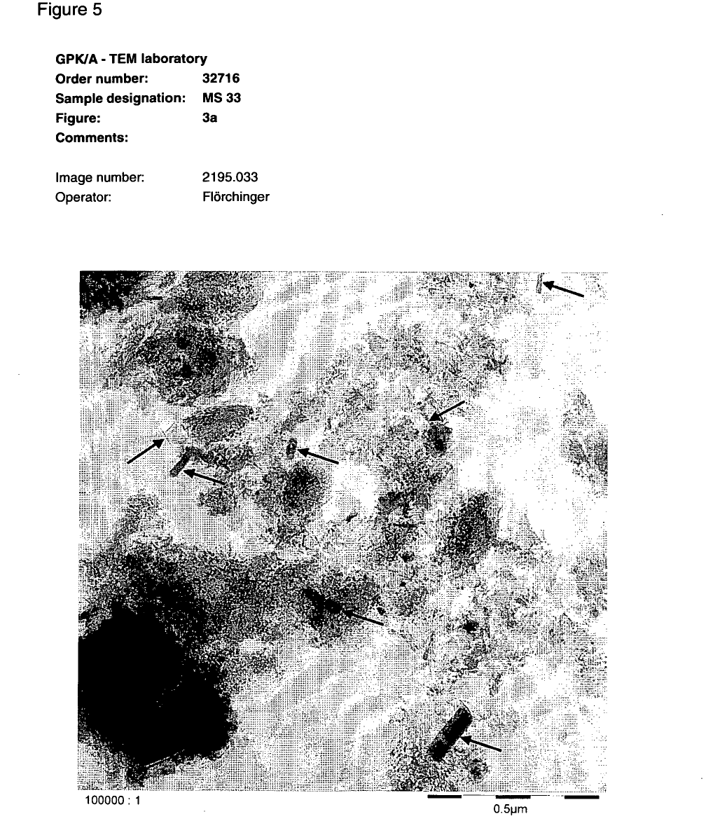

A further Re₂O₇/Al₂O₃ sample, catalyst E (MS33) was subsequently impregnated with a Cs(NO₃) solution, dried and the catalyst was calcined again at 550° C. The catalyst comprised 600 ppm of Cs. Here too, rod-shaped, coarse Cs—Re-containing crystallites could be seen by means of TEM (FIG. 5).

As a person skilled in the art will know, catalytic reactions proceed on the surface of such catalysts. Thus, less noble metal will be required, the higher the dispersion of the active substance. The formation of coarsely crystalline alkali metal perrhenates greatly reduces the dispersion of the Re₂O₇ phase on Al₂O₃-containing support materials, so that a higher total loading with rhenium is generally necessary in order to achieve the same catalytic activity.

1-11. (canceled)

12. A process for producing a supported catalyst which comprises at least 75% by weight of Al₂O₃, whose proportion of Al₂O₃ in the delta or theta modification is, based on the proportion of Al₂O₃, at least 1% and which comprises a rhenium compound and optionally a promoter as active component (A), which comprises
a) converting a support (S) whlich comprises at least 75% by weight of Al₂O₃ and optionally a promoter has been applied is converted into a modified support (S) whose proportion of Al₂O₃ in the delta or theta modification is, based on the proportion of Al₂O₃, at least 1% by calcining the support (S) at a temperature of from 750 to 1000° C.,
b) producing a supported catalyst precursor from the modified support (S) by applying the active component (A) comprising the rhenium compound to the modified support (S) and
c) calcining the supported catalyst precursor at a temperature of from 500 to 750° C.

13. The process according to claim 12, wherein the total proportion of Al₂O₃ in the delta or theta modification is, based on the proportion of Al₂O₃, at least 10%.

14. The process according to claim 12, wherein the proportion of Al₂O₃ in the theta modification is, based on the proportion of Al₂O₃, at least 10%.

15. The process according to claim 12, wherein the support (S) comprises Al₂O₃ together with components selected from the group consisting of SiO₂, aluminosilicates, TiO₂, ZrO₂, MgO, CeO₂ and ZnO.

16. The process according to claim 12, wherein the amount of rhenium compound used as active component (A) in step b) is selected so that the catalyst comprises from 0.01 to 1 mmol of rhenium per gram of catalyst.

17. The process according to claim 12, wherein the supported catalyst has an XRD spectrum in which the maximum of the most intense reflection (main reflection) is in the range from 2 theta >66° to 2 theta <68° and the maximum of one additional reflection or the maxima of a plurality of additional reflections (secondary reflection) are in the range from 2 theta >32.5° to 2 theta <37.4° and the intensity ratio of the respective secondary reflection to the main reflection is at least 0.05.

18. The process according to claim 12, wherein the starting materials are selected so that the total amount of alkali metal compounds, calculated as alkali metal, in the supported catalyst is less than 1000 ppm by weight.

19. The process according to claim 12, wherein the starting compounds are selected so that the total amount of cesium compounds, calculated as elemental cesium, in the supported catalyst is less than 50 ppm by weight.

20. A process for preparing a compound having a nonaromatic C—C double bond or C—C triple bond (compound A) from another compound or mixture of other compounds having a nonaromatic C—C double bond or C—C triple bond (compound B), which comprises bringing the compound (B) into contact with a supported catalyst according to claim 12 at a temperature of from 50 to 500° C.

21. The process according to claim 20, wherein compound (B) is 1-butene or a mixture of butenes comprising 1-butene.

22. A supported catalyst obtainable according to the process as described in claim 18.

23. A supported catalyst obtainable according to the process as described in claim 19.
